(19) United States
(12) Patent Application Publication
(10) Pub. No.: US 2018/0227704 A1
(43) Pub. Date: Aug. 9, 2018

(54) PORTABLE COMMUNICATION TERMINAL, POSITION INFORMATION SHARING SYSTEM, ON-BOARD APPARATUS, AND PROGRAM

(71) Applicant: DENSO CORPORATION, Kariya-city, Aichi-pref. (JP)

(72) Inventors: Masatoshi ITOH, Kariya-city (JP); Hiroki UKAI, Kariya-city (JP)

(73) Assignee: DENSO CORPORATION, Kariya-city, Aichi-pref. (JP)

(21) Appl. No.: 15/580,777

(22) PCT Filed: Jun. 8, 2016
(86) PCT No.: PCT/JP2016/002777

§ 371 Date: Dec. 8, 2017

(30) Foreign Application Priority Data
Jun. 17, 2015 (JP) 2015-122004

(51) Int. Cl. H04W 4/02; G01C 21/36; G01C 21/20; G08G 1/0969; G08G 1/0968

(52) U.S. Cl. CPC H04W 4/023; G01C 21/362; G01C 21/20; H04W 4/027; G08G 1/0969; G08G 1/096827; G08G 1/096844; G01C 21/3655

(57) ABSTRACT

A portable communication terminal includes: in a portable body, a communication device that communicates with an external portion and a display device that displays information. The portable communication terminal includes: a host device position detector; a position information acquirer acquiring member position information, which is position information of a portable communication terminal owned by another member configuring a group with the owner; and a display controller that performs a shared-position-information display process in which the position of each of the portable communication terminals owned by group members is displayed together with a map, on a screen of the display device, based on the host device position information and the member position information. During the shared-position-information display process, the display controller specifies the portable communication terminal to be displayed, and adjusts a display of the map to a reduced scale, at which all positions of the portable communication terminals are displayed.

### CROSS REFERENCE TO RELATED APPLICATION

The present application is based on Japanese Patent Application No. 2015-122004 filed on Jun. 17, 2015, the disclosure of which is incorporated herein by reference.

### TECHNICAL FIELD

The present disclosure relates to a portable communication terminal, a position-information sharing system, an on-board apparatus, and a program, which enable sharing of position information among group members such as friends.

### BACKGROUND ART

In a portable communication terminal such as a smartphone, there has been provided an application (service) for facilitating meeting of members such as friends in a group at the time of their meeting by sharing position information of each other and displaying the information on a map screen. For example, in a technique disclosed in Patent Literature 1, when a plurality of members, including a user, in a group is to meet, a GPS function of a smartphone of each member is used to detect a position of a host device and transmit the detected position to a server. The server collects the position information of each member and transmits the obtained information to each of the smartphones of the members.

Accordingly, the position information of each of the members is displayed on a screen of a display device 101 of the user's smartphone, as shown in FIG. 19A. In this case, the current positions of the respective members (four members in FIG. 19A) are displayed with face icons I on a map centered at a set waiting position P (displayed with a pin) on the display screen. In this case, position information is transmitted from the smartphone to the server every predetermined time (60 seconds), and the server sequentially updates the current position information of each member having transmitted the position information.

### PRIOR ART LITERATURES

### Patent Literature

Patent Literature 1: JP 2015-72139 A

### SUMMARY OF INVENTION

When the position of each group member is to be displayed for meeting, the user adjusts a reduced scale of the map displayed on the display device 101 such that the positions of all the members are displayed. However, since each member gradually moves toward the waiting position P, as shown in FIG. 19B, the face icons I of the members are displayed as gathering and overlapping in the center portion with the lapse of time, and the display thus may enter a state of being hard to identify who and where each face icon I is.

When the positions of the members come close and become hard to see, the user may manually adjust the map reduced scale larger. However, when the reduced scale is made larger at an early stage, as shown in FIG. 19C, some member (the face icon I) might get out of the map and not be able to be displayed. For this reason, the reduced scale may be preferably made larger in stages with the movement of the members, but this requires the user to perform a troublesome operation. Specifically, for example, when the member moving by automobile is moving at a high moving speed, the adjustment of the reduced scale is repeated in a short time interval, which is inconvenient.

It is an object of the present disclosure to provide a portable communication terminal, a position-information sharing system, an on-board apparatus, and a program which enable sharing of position information among group members and display of position information of each member in an easily viewable state for the user.

According to one aspect of the present disclosure, a portable communication terminal, in a body portable by an owner, including: a communication device that communicates with an external portion; and a display device that displays information, is provided. The portable communication terminal includes: a host device position detector that detects a position of a host device; a position information acquirer that acquires member position information, which is position information of a portable communication terminal owned by another member configuring a group with the owner, via the communication device; and a display controller that performs a shared-position-information display process in which the position of each of the portable communication terminals owned by group members is displayed together with a map, on a screen of the display device, based on host device position information detected by the host device position detector and the member position information acquired by the position information acquirer. At a time of performing the shared-position-information display process, the display controller specifies the portable communication terminal to be displayed, and adjusts a display of the map to a predetermined reduced scale, at which all positions of the portable communication terminals, which are specified, are displayed.

According to another aspect of the present disclosure, a position-information sharing system including: a portable communication terminal that is owned by each member configuring a group; a position information management server that is capable of communicating with each of the portable communication terminals; and an on-board apparatus that is provided in a vehicle which each of the members is in and connectable with each of the portable communication terminals, is provided. The portable communication terminal includes, in a body portable by an owner; a communication device that communicates with an external portion, a display device that displays information, a connector that connects with the on-board apparatus, a host device position detector that detects a position of a host device, a transmitter that transmits host device position information detected by the host device position detector to the position information management server via the communication device, a position information acquirer that acquires member position information, which is position information of a portable communication terminal owned by another member configuring the group, from the position information management server via the communication device, a display controller that performs a shared-position-information display process in which the position of each of the portable communication terminals of the group members is displayed, together with a map, on a screen of the display device, based on the host device position information detected by the host device position detector and the member position information acquired by the position information acquirer, and a transfer part that transfers the member position information, which is acquired, to the on-board apparatus. The position information management server includes a receiver that receives member position information, which is position information of each of the portable communication terminals of the members configuring the group, from each of the portable communication terminals of each of the members, and a transmitter that transmits the member position information to each of the portable communication terminals configuring the group. The on-board apparatus includes an on-board display device provided in a cabin and capable of displaying a host-vehicle position on the map, a connector connected with the portable communication terminal, and an on-board display controller that performs the shared-position-information display process in which the position of each of the portable communication terminals of the group members is displayed together with the map, on a screen of the on-board display device, based on the member position information transferred from the portable communication terminal. At a time of performing the shared-position-information display process, the on-board display controller specifies each of the portable communication terminals to be displayed, and adjusts a display of the map to a predetermined reduced scale, at which all the positions of the specified portable communication terminals are displayed.

According to another aspect of the present disclosure, there is provided an on-board apparatus that includes an on-board display device mounted in a vehicle in which each of the members is on board, that is provided in a cabin, and that is capable of displaying a host-vehicle position on the map, and a connector that connects with the portable communication terminal, the on-board apparatus configuring a position-information sharing system. The on-board apparatus includes an on-board display controller that performs a shared-position-information display process in which the position of each of the portable communication terminals of the group members is displayed, together with a map on a screen of the on-board display device, based on the member position information transmitted from the portable communication terminal. At the time of performing the shared-position-information display process, the on-board display controller specifies each of the portable communication terminals to be displayed, and adjusts the display of the map to a predetermined reduced scale, at which all the positions of the specified portable communication terminals can be displayed.

According to another aspect of the present disclosure, a program causing a computer to execute a shared-position-information display process, the computer being incorporated into a portable communication terminal which includes, in a body portable by an owner, a communication device that communicates with an external portion and a display device that displays information is provided. The program causes the computer to: detect a position of a host device; acquire member position information, which is position information of each of portable communication terminals owned by another member configuring a group with the owner, via the communication device; and perform a shared-position-information display process in which the position of each of the portable communication terminals owned by the group members is displayed together with a map, on a screen of the display device, based on a detected host device position information and the acquired member position information, specify each of portable communication terminals to be displayed at a time of performing the shared-position-information display process, and adjust a display of the map to a predetermined reduced scale, at which all the positions of the portable communication terminals, which are specified, are displayed, at the time of performing the shared-position-information display process.

According to the above configuration, when the shared-position-information display process is performed by the display controller, the position information acquirer acquires member position information, which is position information of each of portable communication terminals owned by the user (owner) and by other members configuring a group. Then, the display controller displays the position of each of the portable communication terminals of the group members, together with a map, on a screen of the display device.

At this time, the display controller specifies the portable communication terminals to be displayed, and adjusts the display of the map to a predetermined reduced scale, at which all the positions of the specified portable communication terminals can be displayed. Accordingly, the required position of each of the portable communication terminals of the group members can always be displayed on the map screen without deviating from the screen. In this context, the map reduced scale is automatically adjusted, thereby enabling easily identifiable display of the position of each of the members.

According to the present disclosure, it is possible to share position information among group members and display position information of each member in an easily viewable state for the user.

### BRIEF DESCRIPTION OF DRAWINGS

The above and other aspects, features and advantages of the present disclosure will become more apparent from the following detailed description made with reference to the accompanying drawings. In the drawings:

FIG. 1 is a block diagram schematically showing a configuration of a position-information sharing system according to a first embodiment of the present disclosure;

FIG. 2 is a flowchart showing a process procedure for detecting and transmitting a host device position in a smartphone;

FIG. 3 is a flowchart showing a process procedure for sharing position information, executed by the smartphone and a position information management server;

FIG. 4 is a flowchart showing a detailed process procedure of S12 in FIG. 3;

FIG. 5 is a flowchart showing a detailed process procedure of S13 in FIG. 3;

FIG. 6A is a diagram showing an example of screen display on a display part;

FIG. 6B is a diagram showing an example of the screen display on the display part;

FIG. 7A is a diagram showing another example of the screen display on the display part;

FIG. 7B is a diagram showing another example of the screen display on the display part;

FIG. 8A is a diagram showing a yet another example of the screen display on the display part;

FIG. 8B is a diagram showing a yet another example of the screen display on the display part;

FIG. 8C is a diagram showing a yet another example of the screen display on the display part;

FIG. 9 is a block diagram schematically showing a configuration of a position-information sharing system according to a second embodiment;

FIG. 10 is a flowchart showing a process procedure for sharing position information, executed by the smartphone, the position information management server, and a vehicle navigation apparatus;

FIG. 11 is a diagram schematically showing a configuration of a position-information sharing system according to a third embodiment;

FIG. 12 is a diagram schematically showing a configuration of a moving speed database;

FIG. 13 is a flowchart showing a process procedure for detecting and transmitting a host device position in the smartphone;

FIG. 14 is a flowchart showing a process procedure for sharing position information, executed by the smartphone and the position information management server;

FIG. 15A is a diagram showing an example of a display screen;

FIG. 15B is a diagram showing an example of the display screen;

FIG. 16 is a flowchart showing a process procedure for sharing position information, executed by the smartphone and the position information management server according to a fourth embodiment;

FIG. 17 is a diagram showing an example of the display screen;

FIG. 18 is a flowchart showing a process procedure for sharing position information, executed by the smartphone and the position information management server according to a fifth embodiment;

FIG. 19A is a diagram showing an example of the display screen in a conventional example;

FIG. 19B is a diagram showing an example of the display screen in the conventional example; and

FIG. 19C is a diagram showing an example of the display screen in the conventional example.

### DESCRIPTION OF EMBODIMENTS

### First Embodiment

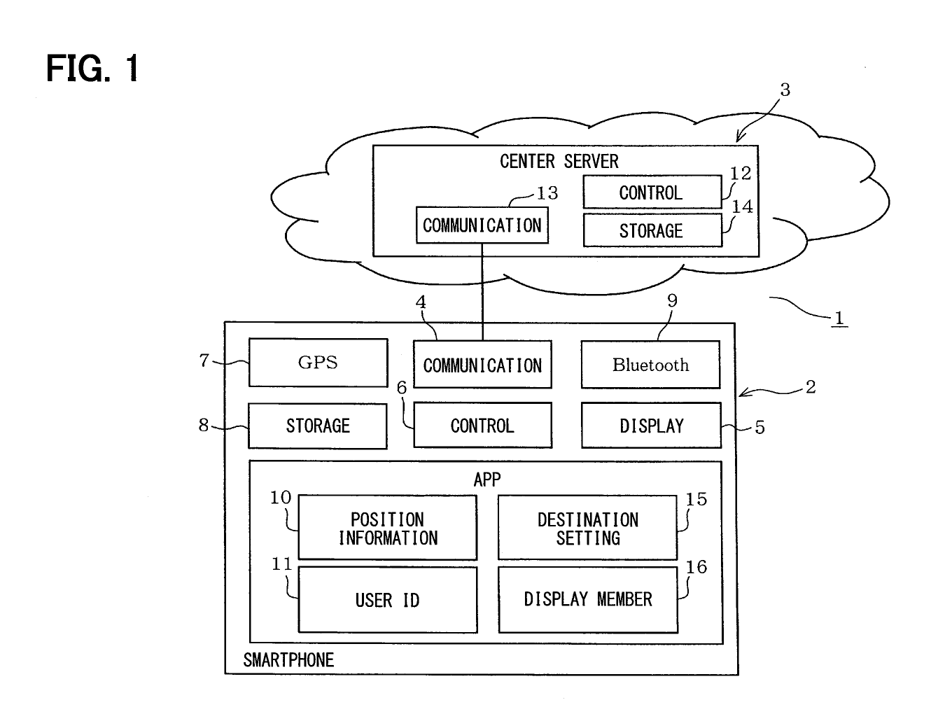

Hereinafter, a first embodiment of the present disclosure will be described with reference to FIGS. 1 to 8C. In each embodiment described below, a smartphone is taken as a specific example of the portable communication terminal owned by a user (an owner). FIG. 1 schematically shows a configuration of a position-information sharing system 1 according to the present embodiment. The position-information sharing system 1 is used, for example, by group members such as friends for meeting or for some other purpose, while sharing position information of each other.

The position-information sharing system 1 includes a smartphone 2 as the portable communication terminal owned by the user, and a position information management server 3 provided in an information center and communicable with the smartphone 2 via the Internet or the like. At this time, smartphones 2 are owned by the respective members being the user and a plurality of people (e.g., friends) who configure the group. Each of those smartphones 2 has an application that is in advance installed for receiving a position-information sharing service.

The smartphone 2 includes a communicator 4 and a display part 5 in a body in the shape of a rectangular panel (not shown), where a portable operation can be performed. The communicator 4 serves as the communication device that communicates with an external portion. The display part 5 serves as a display device having a touch panel. The smartphone 2 includes in the body a controller 6 that mainly has a computer and performs overall control, a GPS receiver 7, a storage 8 that stores a variety of programs (applications) and data, a connector 9 having, for example, a Bluetooth (register trade mark) module, or the like.

The controller 6 executes an application, to achieve a function of a position information acquirer 10 as the host device position detector that detects the current position of a host device, based on a reception signal of the GPS receiver 7. Further, the controller 6 achieves a function as a user ID generation part 11 that allocates a user ID of the host device. The storage 8 also stores user IDs of the smartphones 2 of the other members configuring the group. Further, the controller 6 achieves a function of a destination setting part 15 that sets a destination where the group members are to meet, and a function of a display member determiner 16 that specifies (determines) members to be displayed at the time of performing a shared-position-information display process described later.

In contrast, the position information management server 3 includes a controller 12 that mainly has a computer and performs overall control, a communicator 13 that communicates with each of the smartphones 2 (the communicator 4), and a storage 14 that stores position information of each smartphone 2. The storage 14 stores information of the user ID of the smartphone 2 of each user and information of which group the smartphone 2 belongs to.

As will be described in action description (flowchart description), when starting the position-information sharing process (service), the position information management server 3 (the controller 12) receives (collects) member position information, which is position information of each member configuring the group, from the smartphone 2 of each member via the communicator 13. The member position information is transmitted to each smartphone 2 of the group member via the communicator 13. Hence, the receiver and the transmitter are configured by the controller 12 and the communicator 13. At this time, the position information management server 3 (the controller 12) is configured to receive and transmit the latest member position information from and to each smartphone 2 described above in a predetermined time interval (e.g., 10 seconds).

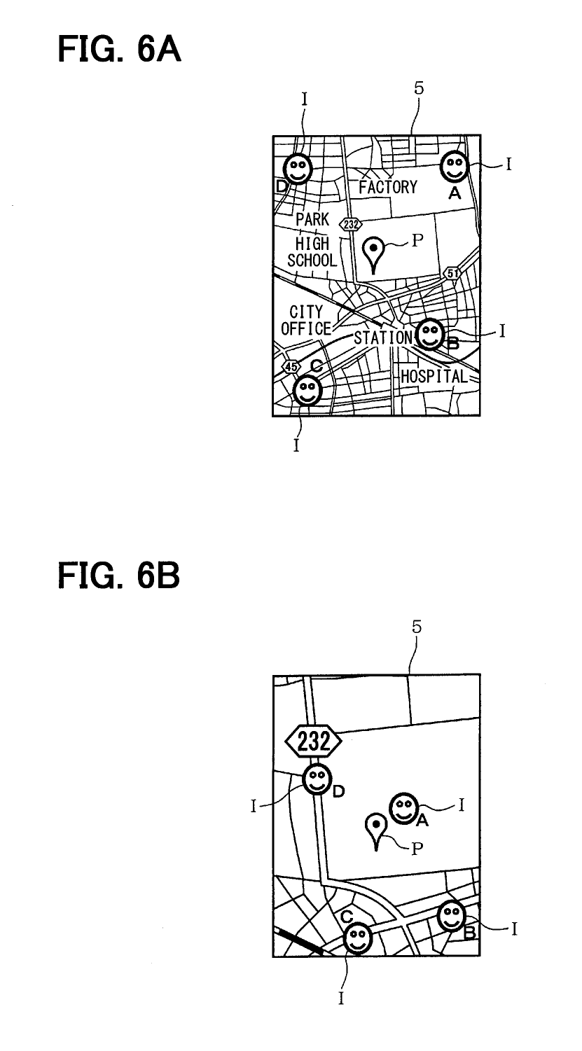

In the position-information sharing system 1, the position-information sharing process (service) for sharing the position information of the smartphone 2 owned by each member can be performed among the members configuring the group. In the position-information sharing service, a position-information sharing application (program) is executed by being activated in each smartphone 2. As illustrated in FIGS. 6A and 6B, a position (a face icon I) of each group member (each smartphone 2) is displayed together with a map on a screen of the display part 5.

Further, in the present embodiment, for example, it is possible to set a destination (a meeting position) P where any of the members (users) come together at the time of performing the position-information sharing process (service). In this case, the destination P can be set, for example, by such a method where the user specifies a place (i.e., a point) desired to be taken as the destination P by the operation of the touch panel, with a map screen (a host device position) displayed on the display part 5 of the smartphone 2. The information of the set destination P is also transmitted to the position information management server 3, is then transmitted to each of the smartphones 2 of all the group members for sharing, and is displayed in the shape of a pin. It is also possible to set a target meeting time on which the group members are to meet at the destination P, along with the above setting.

The controller (the computer) 6 of the smartphone 2 executes a shared-position-information display process by the following routine, at the time of performing the process (service) for sharing the position information in the group with the configuration of software (by execution of the program). First, a routine of host device position detection is executed for detecting the host device position, based on the reception signal of the GPS receiver 7. When the host device position is detected, a routine of host device position transmission is executed for transmitting the host device position information to the position information management server 3 via the communicator 4.

Subsequently, a routine of member position information acquisition is executed for requesting the position information (member position information) of each of the smartphones 2 of the other members configuring the group to the position information management server 3 via the communicator 4, to receive (acquire) member position information transmitted from the position information management server 3. In the present embodiment, the acquired member position information includes the user ID and the position information concerning each of the smartphones 2 of the group members.

Thereafter, a routine of the shared-position-information display process is executed in which the position of each of the smartphones 2 of the group members including the host user (and the destination) is displayed, together with the map, on the screen of the display part 5, based on the detected host device position information and the acquired member position information. Hence, the controller 6 configures the host device position detector, together with the GPS receiver 7, and configures the transmitter and the position information acquirer, together with the communicator 4. Further, the controller 6 functions as the display controller. The program of the controller 6 is stored in advance by being provided via a storage medium such as an optical disk or by being downloaded from an external server via a network.

In the present embodiment, as described in the next function description, the controller 6 detects the host device position and transmits the detected position to the position information management server 3 in a predetermined time interval (e.g., 10 seconds), and acquires (receives) member position information from the position information management server 3 and updates the display in a predetermined time interval (e.g., 10 seconds), at the time of performing the shared-position-information display process. Along with the above, the controller 6 is configured to display all the positions of the respective smartphones 2 to be displayed (having been specified) on the screen of the display part 5 and display the map at a predetermined reduced scale which is set so as to make the map reduced scale as large as possible (adjust the reduced scale automatically).

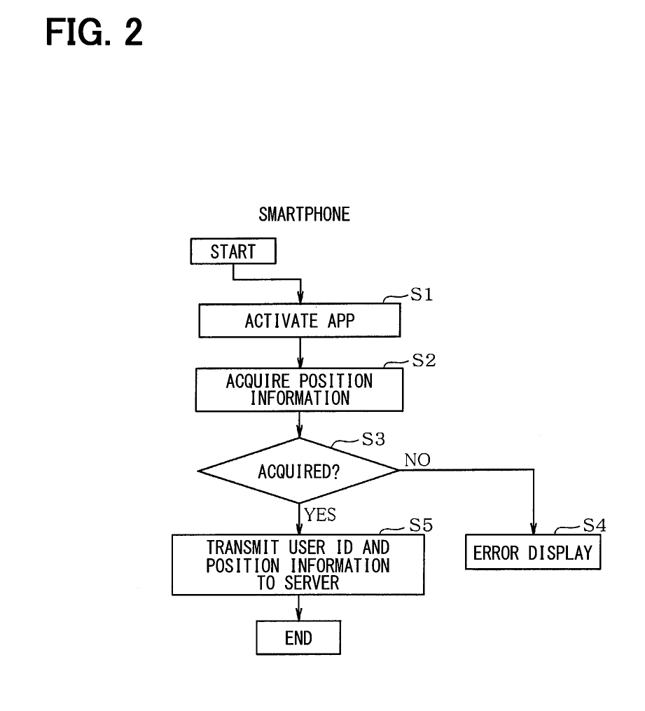

Next, the function of the above configuration will be described with reference to FIGS. 2 to 8A and FIG. 8C. A flowchart of FIG. 2 shows a process procedure for detecting and transmitting a host device position, executed by the controller 6 of each smartphone 2 at the time of performing the position-information sharing process in the group. When the position-information sharing application is activated in S1, the host device position information is acquired (positioned) using GPS in S2.

In S3, it is determined whether the host device position information has been acquired. When the host device position information has not been acquired (NO in S3), an error display is performed in S4. In contrast, when the host device position has been acquired (YES in S3), the host device user ID and the host device position information are transmitted to the position information management server 3 in S5. Although not shown in FIG. 2, the process for detecting the host device position and transmitting the information is repeatedly executed in the predetermined time interval (e.g., 10 seconds).

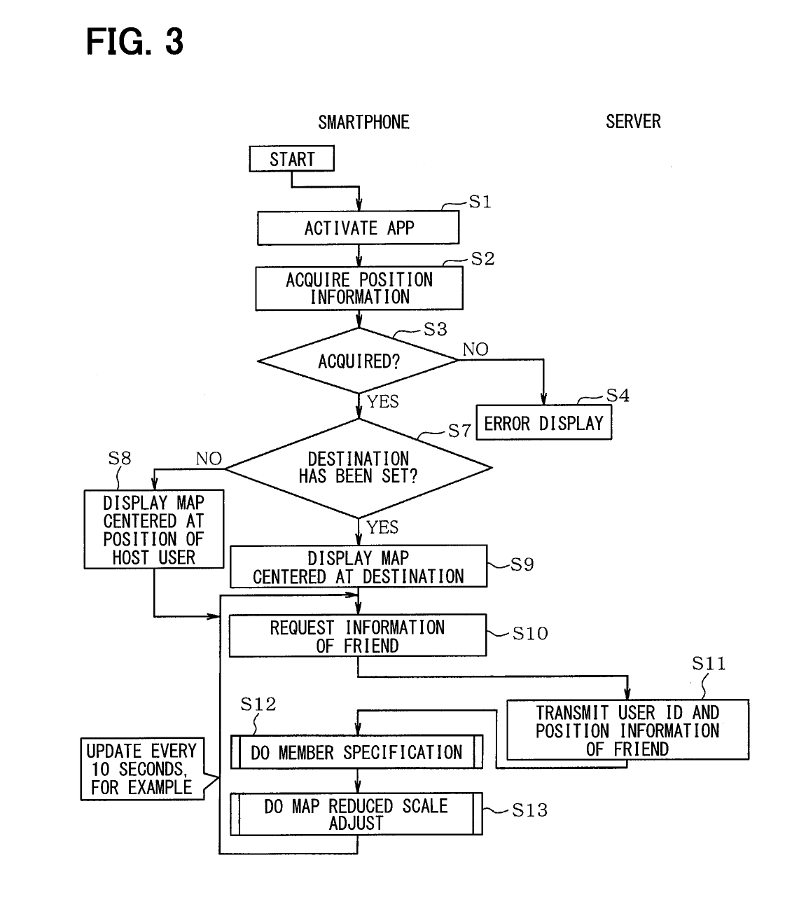

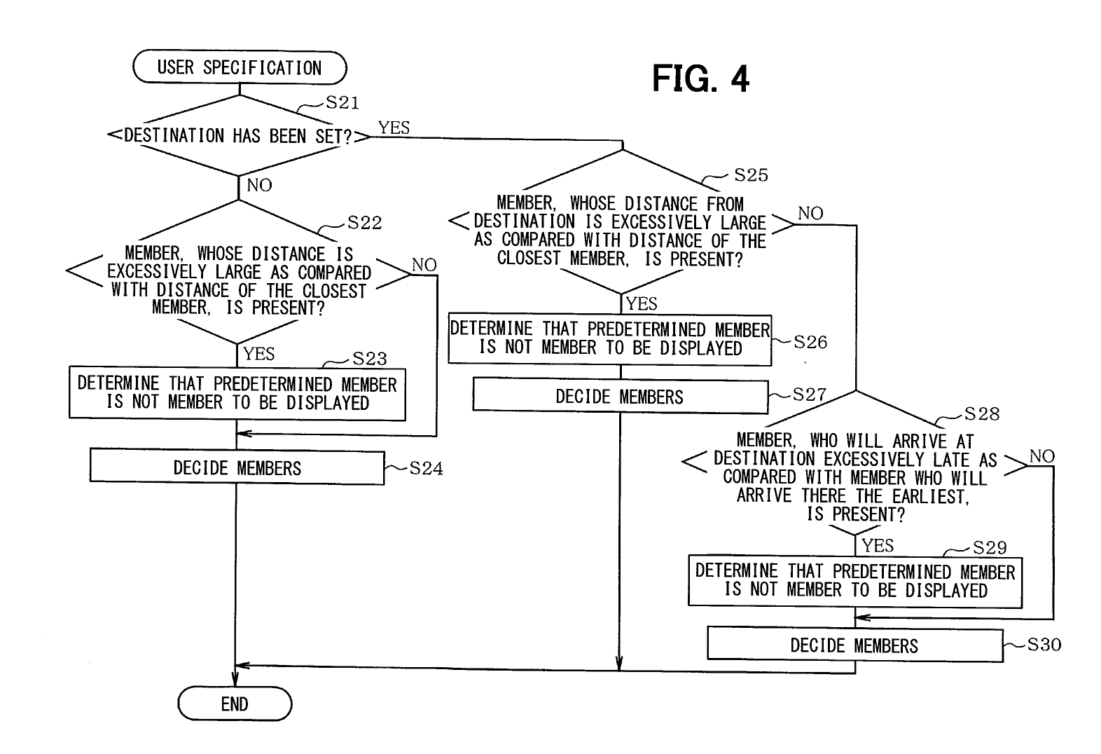

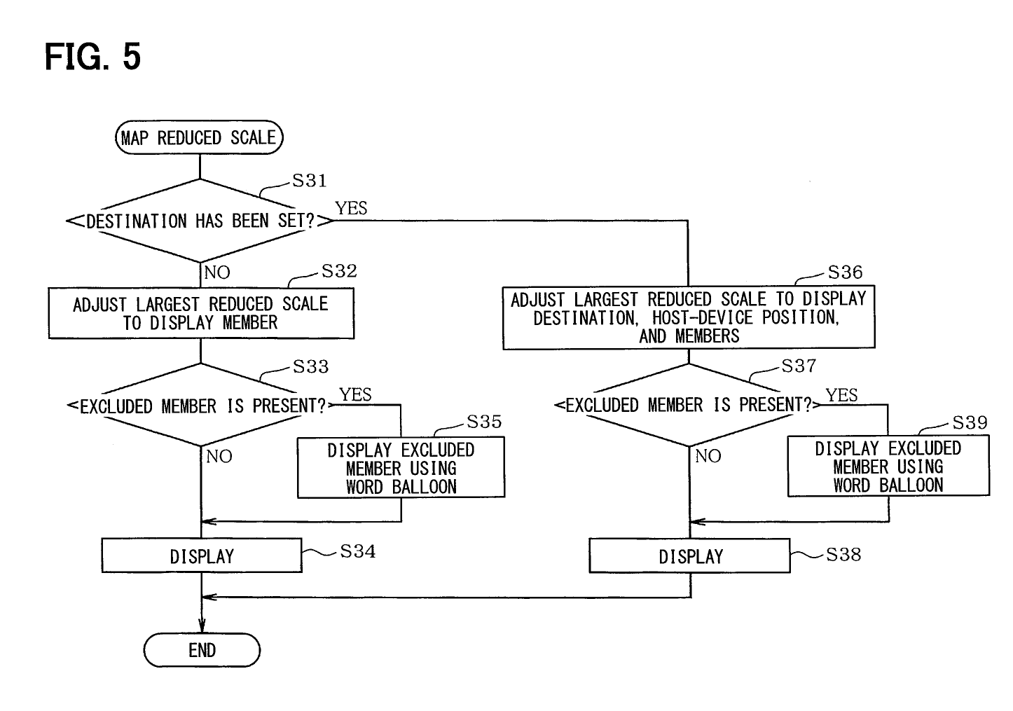

A flowchart of FIG. 3 shows a process procedure (a main routine) concerning display of the shared position information, executed by the smartphone 2 and the position information management server 3. The process of FIG. 3 is performed in parallel with the process of FIG. 2 above in the smartphone 2. A flowchart of FIG. 4 shows a detailed process procedure (sub-routine) for specifying the user (the member) displayed in S12 of FIG. 3, and a flowchart of FIG. 5 shows a detailed process procedure (sub-routine) for adjusting the map reduced scale in S13 of FIG. 3.

In FIG. 3, when the position-information sharing application is started in the smartphone 2 in S1, the host device position information is acquired in S2, and it is determined whether the host device position information has been acquired in S3. When the host device position information has not been acquired (NO in S3), an error display is performed in S4. When the host device position has been acquired (YES in S3), it is determined in subsequent S7 whether the destination P (the meeting place) has been set. When the destination P has been set (YES in S7), a map centered at the destination P is displayed on the screen of the display part 5 in S8, and the process proceeds to S10. When the destination P has not been set (NO in S7), a map centered at the host device position is displayed on the screen of the display part 5 in S9.

In subsequent S10, a request for group position information is transmitted from the smartphone 2 to the position information management server 3. In S11, a User ID and position information (member position information) of each of the smartphones 2 of the members belonging to the corresponding group are transmitted from the position information management server 3 to the smartphone 2 having made the request. When acquiring (receiving) the member position information from the position information management server 3, the smartphone 2 executes a process for specifying the members (the user) to be displayed in S12.

The process for specifying the members to be displayed is executed in accordance with the flowchart of FIG. 4. In S21, it is determined whether the destination P has been set. When the destination P has not been set (NO in S21), in S22, a separate distance is obtained between the host device position and the position of the smartphone 2 of each member of the group from the member position information of each member, to determine the presence or absence of a member whose separate distance to the host device position is excessively large with respect to the separate distance between the host device position and the closest member. Specifically, for example when the separate distance is equal to or greater than five times, and also equal to or greater than 3 km, the separate distance is determined to be excessively large.

When the member whose separate distance is excessively large is present (YES in S22), in subsequent S23, the member is determined as the member to be excluded from the display target on the map (displayed in another mode). In subsequent S24, the members to be displayed, except for the member excluded from the display target, are determined (specified). When the member whose separate distance is excessively large is not present (NO in S22), all the members are taken as the display target in S24.

On the other hand, when the destination P has not been set (YES in S21), in S25, a remaining distance of each member to the destination P is obtained from the member position information of each member, to determine the presence or absence of another member whose remaining distance to the destination P is excessively large with respect to the remaining distance of the closest member to the destination P. Specifically, for example when the remaining distance is not less than five times as large, and not smaller than 3 km, the remaining distance is determined to be excessively large. When the member whose remaining distance is excessively large is present (YES in S25), in subsequent S26, the member is determined as the member to be excluded from the display target on the map (displayed in another mode). In subsequent S27, the members to be displayed, except for the member excluded from the display target, are determined (specified).

In contrast, when the member whose remaining distance is excessively large is not present (NO in S25), the process proceeds to S28, and an arrival time at the destination P of each member is obtained from the member position information of each member, to determine the presence or absence of another member who will arrive excessively late as compared with the member who will arrive the earliest. Specifically, for example when the time until arrival will take not less than three times and will be delayed by 10 minutes or more, the arrival is determined to be excessively late. When the member who will arrive excessively late is present (YES in S28), in subsequent S29, the member is determined as the member to be excluded from the display target on the map (displayed in another mode).

In subsequent S30, the members to be displayed, except for the member excluded from the display target, are determined (specified). When the member who will arrive excessively late is not present (NO in S28), all the members are taken as the display target in S30. As described above, when the specification of the members to be displayed is completed, the process returns to FIG. 3, and in subsequent S13, the member position information is displayed on the screen of the display part 5, while the map reduced scale is adjusted.

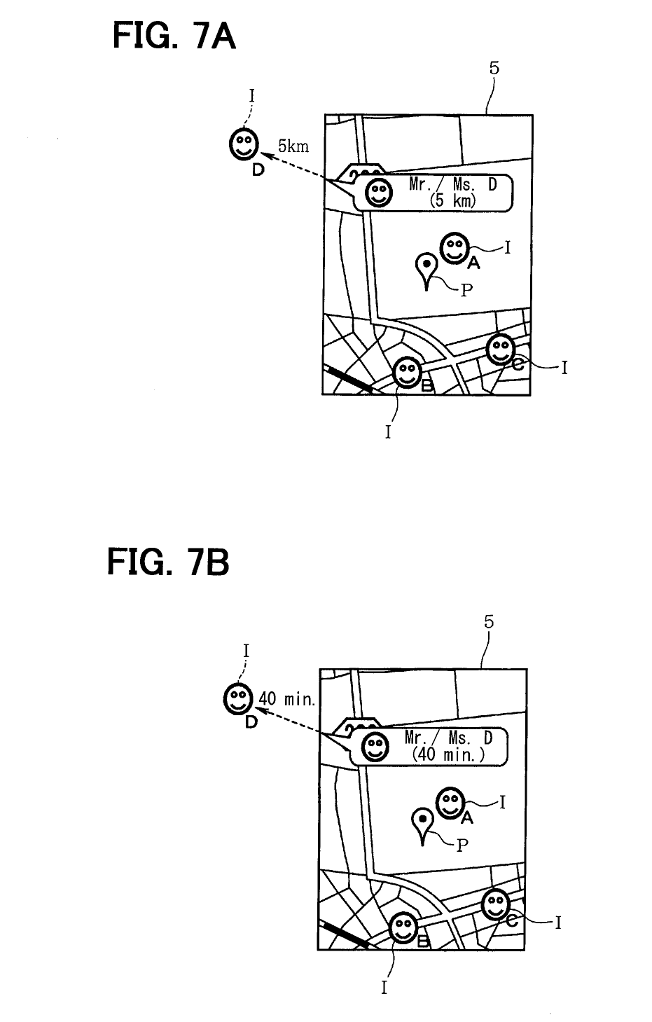

The process for adjusting the map reduced scale is executed in accordance with the flowchart of FIG. 5. First in S61, it is determined whether the destination P has been set. When the destination P has not been set (NO in S61), in S62, all the specified members are displayed and the map reduced scale is adjusted so as to be as large as possible. In S63, the presence or absence of the member having been excluded from the display target is determined. When such a member is not present (NO in S63), the members are displayed as they are in S64. On the other hand, when the member having been excluded from the display target is present (YES in S63), in S65, the member is displayed in another mode, which is a word balloon in this case (referring to FIGS. 7A and 7B).

When the destination P has been set (YES in S61), the destination P, the host device position, and all the specified members are displayed and the map reduced scale is adjusted so as to be as large as possible in S66. In S67, the presence or absence of the member having been excluded from the display target is determined, and when such a member is not present (NO in S67), the members are displayed as they are in S68. On the other hand, when the member having been excluded from the display target is present (YES in S67), in S69, the member is displayed in another mode which is a word balloon also in this case (referring to FIGS. 7A and 7B).

Accordingly, the positions of the smartphones 2 of all the members specified to be displayed are displayed on the screen of the display part 5, and the member position information is displayed, while the map reduced scale is automatically adjusted so as be as large as possible. The process for acquiring and displaying the member position information and specifying and displaying the members to be displayed as above is executed repeatedly in the predetermined time interval (e.g., 10 seconds). Accordingly, the smartphone 2 (the controller 6) acquires the latest member position information in the predetermined time interval (10 seconds), to display all the positions of the respective smartphones 2 to be displayed except for the member extremely separated from the destination P or the host device position, while updating the display of the display part 5, and displays the map at a predetermined reduced scale which has been set so as to make the map reduced scale as large as possible.

Hence, the latest position of each of the smartphones 2 of the group members can always be displayed on the map screen. In this context, the map is adjusted so as to make the reduced scale as large as possible, thereby enabling easily identifiable display of the position of each of the smartphones 2 of the group member without the user manually performing an operation to change the reduced scale. It is a matter of course that the position of each smartphone to be displayed is not deviated from the map screen. The above position-information sharing process is completed by a completion operation performed in any of the smartphones 2, or by arrival of all the group members (all the smartphones 2) at the destination P.

FIGS. 6A and 6B show specific examples of display of the member position information on the display part 5. FIG. 6A illustrates a case where each of the members (A (host), B, C, D) is yet located relatively far from the destination P. At this time, a map screen with a relatively small reduced scale is displayed, and member position information is superimposed and displayed with the face icons I. In contrast, when each member moves with the lapse of time and approaches the destination P, as shown in FIG. 6B, the map reduced scale is automatically adjusted so as to be made relatively large. Hence, also in this case, it is possible to display the positions of the respective smartphones 2 from each other (the positional relation with respect to the destination P) in an easily viewable manner.

FIGS. 7A and 7B show a display example of the display part 5 in the case of displaying the position of the member excluded from the map display target in another mode. FIG. 7A shows an example where D is excluded from the display target, and a remaining distance to the destination P at that time is 5 km. A word balloon appears in the upper part of the map screen (a place where no other member is displayed) from a direction to the position of D on the map, and “D (5 km)” is displayed in the word balloon. FIG. 7B shows an example where, when an arrival time to the destination P is 40 minutes, “D (40 min.)” is displayed in the word balloon.

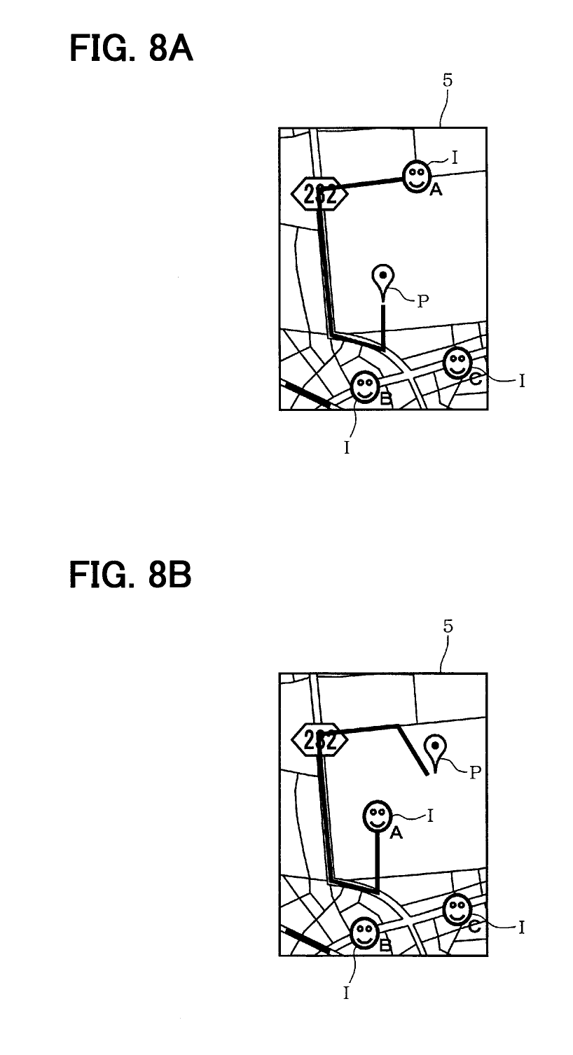

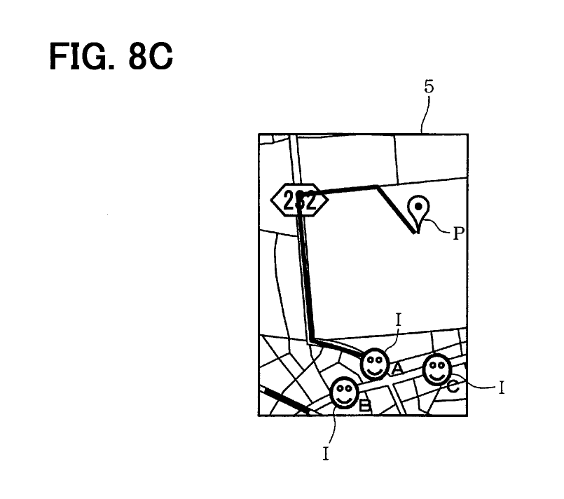

FIGS. 8A to 8C show display examples of the display part 5 in the case of including the destination P. In FIG. 8A, the map reduced scale (and positions to be displayed on the screen) are adjusted such that the positions of the members (three members, A, B, C) and the position of the destination P are all included, with the screen center being not set. In FIG. 8B, adjustment is made such that the positions of all the members and the position of the destination P are all included, with the host device (A) being disposed at the screen center. In FIG. 8C, adjustment is made such that the positions of all the members are included, with the destination P being disposed at the screen center.

As thus described, according to the smartphone 2, the position-information sharing system 1, and the program of the present embodiment, it is possible to share position information among group members and obtain an excellent effect of being able to display position information of each member in a state easily viewable for the user. In particular, in the present embodiment, since it is configured so as to allow setting of the destination P where the group members are to meet, the positional relation among each member, including the destination P, is easily identifiable by viewing the display of the display part 5, which can enhance the convenience for the user.

### Second Embodiment

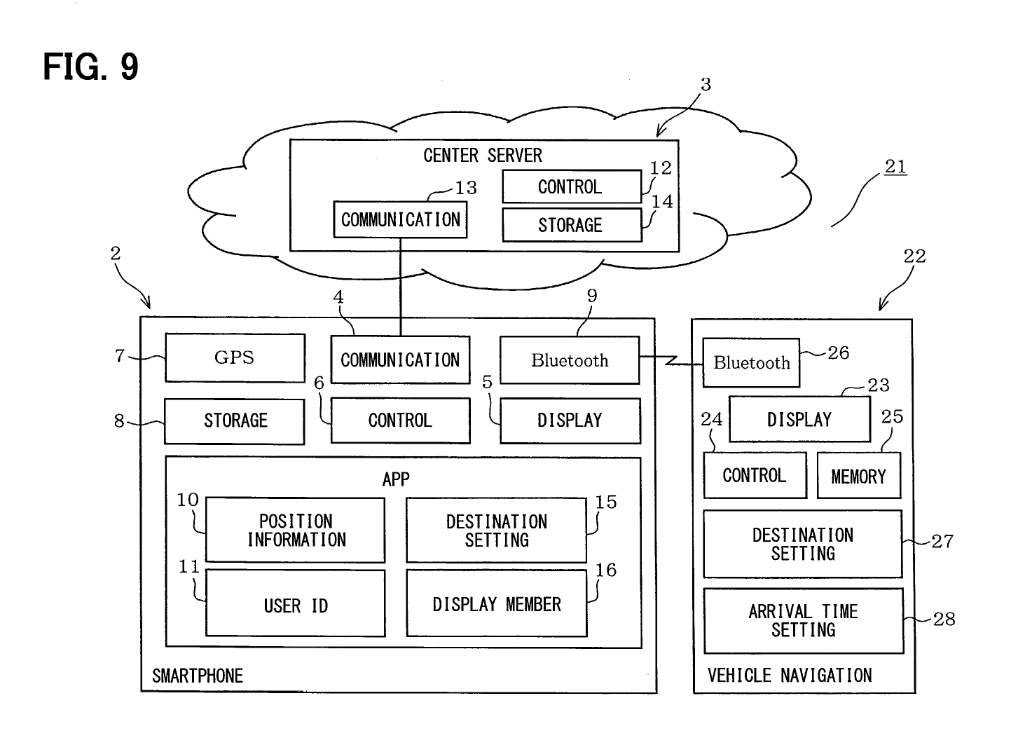

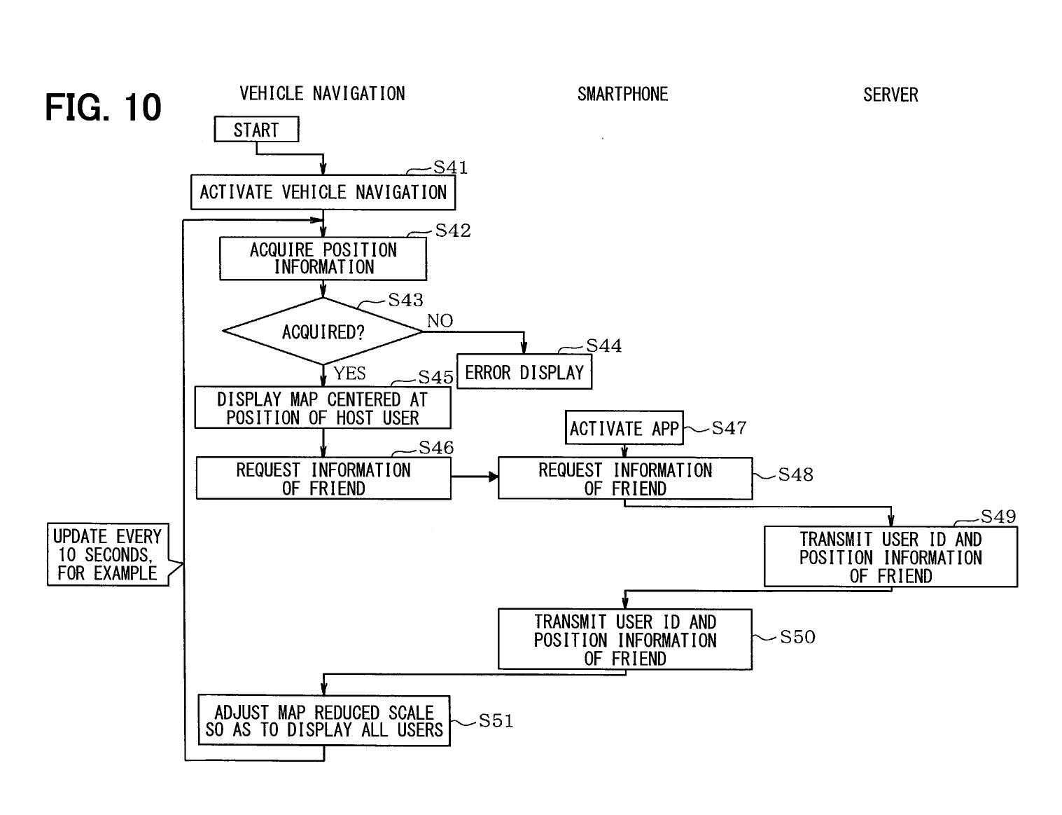

Next, a second embodiment will be described with reference to FIGS. 9 and 10. In each embodiment described below, the same portion as that of the above first embodiment will be provided with the same numeral to omit a new drawing or a detailed description, and a different respect from the first embodiment will mainly be described. A position-information sharing system 21 of the second embodiment is different from the first embodiment in a configuration where the smartphone 2 as the portable communication terminal owned by the user can cooperate with a vehicle navigation apparatus 22 as an on-board apparatus mounted in a vehicle (an automobile) used by the user.

FIG. 9 shows a schematic configuration of the position-information sharing system 21 according to the present embodiment, which has an equivalent configuration to that of the above first embodiment in terms of the smartphone 2 and the position information management server 3. The vehicle navigation apparatus 22 includes a display part 23 as the on-board display device which is installed in a cabin of an automobile and in which a map screen and the like are displayed, a controller 24 that mainly has a computer and performs overall control, and a memory 25 that stores programs and a variety of pieces of data including map data. Further, the vehicle navigation apparatus 22 includes a connector 26 as the connector having Bluetooth module, for example, and connectable with the smartphone 2 (the connector 9) Moreover, the vehicle navigation apparatus 22 includes a destination setting part 27, an arrival-time setting part 28, and further, a host-vehicle position detector, not shown, having the GPS receiver and the like.

At this time, a cooperative application for cooperating with the vehicle navigation apparatus 22 is installed in advance in the smartphone 2 of the user, and similarly, a cooperative application for cooperating with the smartphone 2 is installed in the vehicle navigation apparatus 22. With such applications installed, by bringing the smartphone 2 into the cabin of the automobile, the connector 9 and the connector 26 are connected by a wireless communication in a Bluetooth (register trade mark) system, and hence cooperative operations of the smartphone 2 and the vehicle navigation apparatus 22 can be executed. The connector 9 thus functions as the connector that connects the vehicle navigation apparatus 22 being another device.

In the present embodiment, as described in the next function description (flowchart description), when the shared-position-information display process is performed with the smartphone 2 and the vehicle navigation apparatus 22 in the cooperative state, the smartphone 2 (the controller 6) detects host device position information and transmits the detected information to the position information management server 3 (referring to FIG. 2). Further, position information (member position information) of each of the smartphones 2 of the other members configuring the group is requested to the position information management server 3, and the member position information transmitted from the position information management server 3 is acquired. The acquired member position information is transmitted (transferred) from the smartphone 2 to the vehicle navigation apparatus 22.

The vehicle navigation apparatus 22 (the controller 24) performs the shared-position-information display process in which the position of each of the smartphones 2 of the group members including the host user (and the destination P) are displayed together with the map on the screen of the display part 23, based on the member position information and host-vehicle position information (or host device position information). Also in this case, it is configured such that the displayed member position information and host-vehicle position information are updated in a predetermined time interval (e.g., 10 seconds), all the positions of the respective smartphones 2 to be displayed (having been specified) are displayed on the screen of the display part 23, and the map at a predetermined reduced scale is displayed, which has been set so as to make the map reduced scale as large as possible (adjust the reduced scale automatically).

Accordingly, in the present embodiment, the controller 24 of the vehicle navigation apparatus 22 functions as the on-board display controller. When the destination P is set by the destination setting part 27, the vehicle navigation apparatus 22 searches an appropriate route to the destination P and performs routing assistance. Along with this, the arrival-time setting part 28 calculates the time required (an expected arrival time) until the arrival at the destination (the destination P), based on the route. When information of the destination P is received (or set) on the smartphone 2 side, the information of the destination P is transmitted to the vehicle navigation apparatus 22, and a similar process is performed.

A flowchart of FIG. 10 shows the process procedure for sharing position information, executed by the vehicle navigation apparatus 22, the smartphone 2 in the cooperative state with the vehicle navigation apparatus 22, and the position information management server 3 in the present embodiment. In the smartphone 2, the process for detecting the host device position and transmitting the information, described in FIG. 2, is repeatedly executed in a predetermined time interval (e.g., 10 seconds) in parallel with the process shown in FIGS. 6A and 6B. This process is equivalent to that in the first embodiment (the flowchart of FIG. 2), and hence its description will be omitted.

As shown in FIG. 10, the vehicle navigation apparatus 22 (the controller 24) is activated in S41 and acquires host-vehicle position information in S42. Then, it is determined whether the host-vehicle position information has been acquired in S43. When the host-vehicle position information has not been acquired (NO in S43), an error display is performed in S44. When the host device position information has been acquired (YES in S43), a map centered at the host-vehicle position is displayed on the screen of the display part 23 in S45.

In subsequent S46, a request for group position information of each of the smartphones 2 of the other members configuring the group is transmitted from the vehicle navigation apparatus 22 to the smartphone 2. That is, information of each of the friends in the group is requested in S46. In the smartphone 2 (the controller 6), when the position-information sharing application is activated in S47, in response to the request from the vehicle navigation apparatus 22, a request for member position information is transmitted to the position information management server 3 in S48. That is, information of each of the friends in the group is requested. Then, in S49, a User ID and position information (member position information) of each of the smartphones 2 of the members belonging to the group are transmitted from the position information management server 3 to the smartphone 2 having made the request.

When acquiring (receiving) the member position information from the position information management server 3, the smartphone 2 transmits (transfers) the member position information to the vehicle navigation apparatus 22 in S50. In the vehicle navigation apparatus 22, in S51, the positions of the smartphones 2 of all the members are displayed on the screen of the display part 23, and the member position information is displayed, while the map reduced scale is automatically adjusted so as to be as large as possible.

The process for acquiring and displaying the member position information is executed repeatedly in a predetermined time interval (e.g., 10 seconds). Accordingly, the vehicle navigation apparatus 22 (the controller 24) acquires the latest member position information in the predetermined time interval (10 seconds), to display all the positions of the respective smartphones 2 to be displayed, while updating the display of the display part 23, and displays the map at a reduced scale which has been set so as to be as large as possible.

According to the present embodiment, similarly to the above first embodiment, it is possible to share position information among group members and obtain an excellent effect of being able to display position information of each member in an easily viewable state for the user. By using the vehicle navigation apparatus 22, which is the on-board apparatus connected to the smartphone 2, and allotting a part of the function, it is possible to reduce a load of the smartphone 2 and thereby perform the process with higher quality (at a higher rate), and also possible to obtain advantages, such as an increase in convenience due to the cooperation.

In the second embodiment, it has been configured such that, separately from the host device position detector of the smartphone 2, the host-vehicle position detected by the vehicle navigation apparatus 22 detecting the host device position is displayed. However, it may be configured such that the vehicle navigation apparatus 22 receives the host device position information of the smartphone 2 and displays the position of the host vehicle (the host device) based on the received information. Alternatively, it may be configured such that the smartphone 2 acquires, as the host device position, the position detected by the host-vehicle position detecting function of the vehicle navigation apparatus 22 and transmits the acquired position. It can also be configured such that the function (the function to communicate with the position information management server 3) of the position information acquirer in the portable communication terminal is allotted to the on-board apparatus.

Although not described in detail in the second embodiment, when the smartphone 2 and the vehicle navigation apparatus 22 are cooperated with each other, the process performed by the display controller (the process for specifying members to be displayed and automatically adjusting the map reduced scale at the time of position display) may be performed only on the vehicle navigation apparatus 22 side (by the controller 24). That is, on the smartphone 2 side, it may be configured such that, when the controller 6 displays the shared position information on the display part 5, the map reduced scale is set and fixed so as to be changeable by the user's operation, and the map reduced scale is not cooperated with the display screen of the vehicle navigation apparatus 22 (is made independently adjustable).

### Third Embodiment

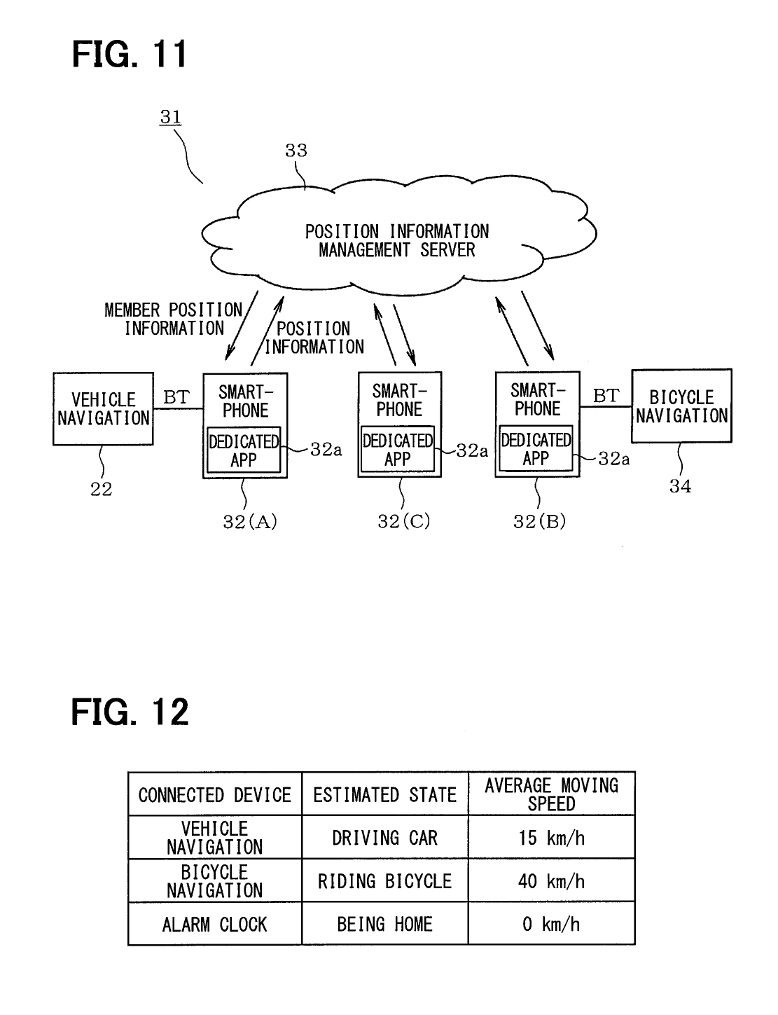

Next, a third embodiment of the present disclosure will be described with reference to FIGS. 11 to 15A and FIG. 15B. FIGS. 7A and 7B schematically show a configuration of a position-information sharing system 31 according to the present embodiment. The position-information sharing system 31 includes a smartphone 32 as a portable communication terminal owned by each member configuring a group of friends, for example, and a position information management server 33 communicable with the smartphone 32. FIG. 11 shows three smartphones 32, for example, and when those are to be distinguished, A, B, C are added to numeral 32.

Although not illustrated in detail, similarly to the above first embodiment, each of the smartphones 32 includes in a body a communicator 4 that serves as the communication device for communicating with an external portion, a display part 5 that serves as the display device having a touch panel, a controller 6 that mainly has a computer and performs overall control, a GPS receiver 7 that configures the host device position detector, a storage 8 that stores a variety of programs (applications) and data, a connector 9 having a Bluetooth (register trade mark) module, and the like. Each smartphone 32 includes a dedicated application 32a for executing the position-information sharing process (receiving the position-information sharing service).

At this time, in the present embodiment, each smartphone 32 is connectable with another device by the connector 9 as the connector. In this context, as another device, other than the vehicle navigation apparatus 22 being the on-board apparatus described in the above second embodiment, each smartphone 32 can be connected with a bicycle navigation device 34 mounted on a bicycle, IT related information equipment such as a personal computer, and a variety of household electric appliances as IoT (Internet of Things) devices provided in a house (a TV, audio equipment, illumination equipment, an air conditioner, a water heater, etc.). FIG. 11 illustrates a state where the vehicle navigation apparatus 22 is connected to the smartphone 32(A) and the bicycle navigation device 34 is connected to the smartphone 32(B).

In contrast, although not shown in detail, the position information management server 33 includes a controller 12 that mainly has a computer, a communicator 13 that communicates with each of the smartphones 32 (the communicators 4), a storage 14 that stores a variety of pieces of data, and the like. The position information management server 33 (the controller 12) receives (collects) member position information, which is position information of each member configuring the group, from the smartphone 32 of each member via the communicator 13 and transmits the member position information to each smartphone 32.

At this time, the storage 14 stores a moving speed database as shown in FIG. 12. The moving speed database shows the relation between the kind of the device connected to the smartphone 32 and an average moving speed of the smartphone 32 (the user who owns the smartphone 32). When the device is the vehicle navigation apparatus 22, the user is supposed to be in an automobile, and the average moving speed is estimated to be 40 km/h. When the device is the bicycle navigation device 34, the user is supposed to be on a bicycle, and the average moving speed is estimated to be 15 km/h. When the device is a household electric appliance, the user is supposed to be home. Hence in the present embodiment, the position information management server 33 includes a speed estimator that estimates the moving speed of each smartphone 32.

As described in the next flowchart description, in the present embodiment, the controller 6 of the smartphone 32 executes the shared-position-information display process with the configuration of software (by execution of the program). In this process, the host device position information is detected and transmitted to the position information management server 33, the member position information transmitted from the position information management server 33 is acquired, and the shared-position-information display process is performed in which the position of each of the smartphones 32 of the group members including the host user (and the destination) is displayed, together with the map, on the screen of the display part 5. It is configured such that the member position information and the host device position information displayed on the display part 5 are updated in a predetermined time interval (e.g., 10 seconds), all the positions of the respective smartphones 32 to be displayed are displayed on the screen of the display part 5, and the map is displayed at a predetermined reduced scale which has been set so as to make the map reduced scale as large as possible (the reduced scale is adjusted automatically).

In the present embodiment, the member position information transmitted from the position information management server 33 includes information of the moving speed, along with the user ID and the position information of each of the smartphones 32 of the group members. The controller 6 of the smartphone 32 functions as the time calculator that calculates an arrival time at the destination P, based on the moving speed of each of the smartphones 32 of the group members. At the time of performing the shared-position-information display process, the controller 6 calculates an expected arrival time at the destination P, and excludes from the display target the smartphone 32 of the member whose arrival time is determined to exceed a predetermined time (e.g., a target arrival time+a (e.g., 10 minutes)).

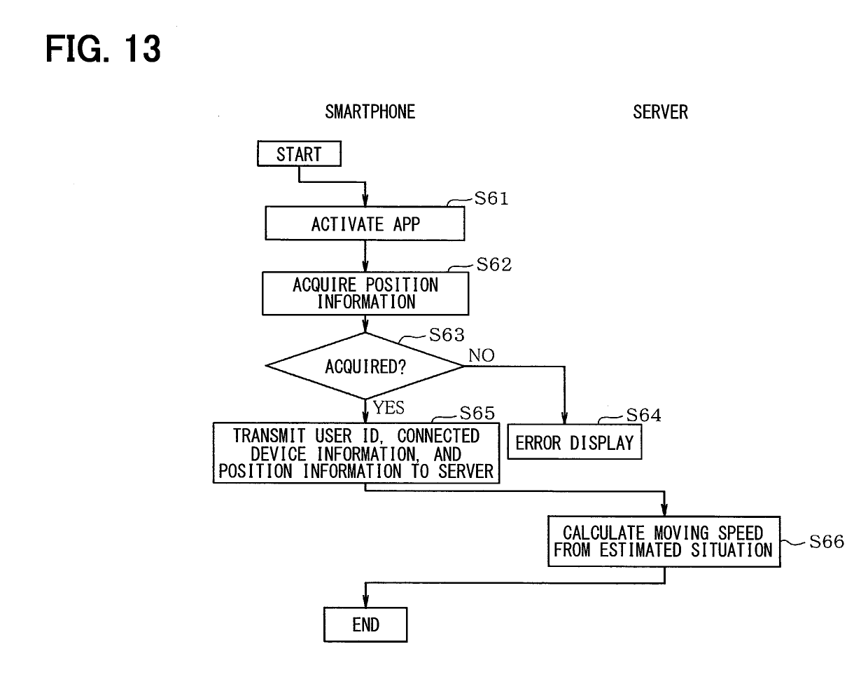

A flowchart of FIG. 13 shows a process procedure for detecting and transmitting a host device position, executed by each smartphone 32 (the controller 6) and the position information management server 33 (the controller 12). That is, in the smartphone 32, when the position-information sharing application is activated in S61, the host device position information is acquired using GPS in S62. In S63, it is determined whether the host device position information has been acquired. When the host device position information has not been acquired (NO in S63), an error display is performed in S64.

On the other hand, when the host device position has been acquired (YES in S63), in S65, the host device user ID, information (the kind, the presence or absence) of the connected device, and the host device position information are transmitted to the position information management server 33. This process for detecting the host device position and transmitting the information is repeatedly executed in a predetermined time interval (e.g., 10 seconds). When the information is transmitted to the position information management server 33, the position information management server 33 (the controller 12) obtains the moving speed of the smartphone 32 based on the moving speed database of FIG. 12, from the information (the kind, the presence or absence) of the connected device.

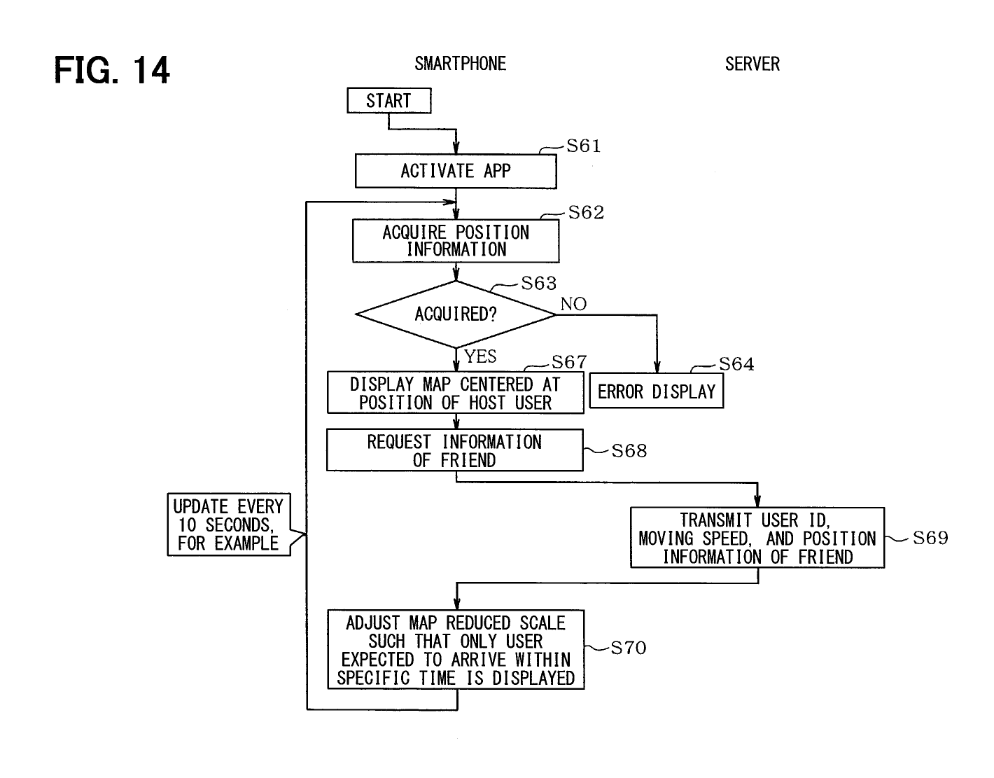

A flowchart of FIG. 14 shows a process procedure for sharing (displaying) position information, executed in parallel with the above process by each smartphone 32 (the controller 6) and the position information management server 33 (the controller 12). That is, in the smartphone 32, the application is activated (S61), and, the host device position information is acquired (S62). When the host device position is acquired (YES in S63), a map centered at the destination P is displayed on the screen of the display part 5 in S67.

In subsequent S68, a request for group position information of each of the smartphones 32 of the group members is transmitted from the smartphone 32 to the position information management server 33. Then, in S69, the position information management server 33 transmits the User ID, the moving speed, and the position information (the member position information) of each of the smartphones 32 of the members belonging to the group to the smartphone 32 having made the request. When the smartphone 32 acquires (receives) the member position information from the position information management server 33, in S70, the position of each of the smartphones 32 of the group members is displayed on the screen of the display part 5, while the map reduced scale is automatically adjusted so as to be as large as possible.

At this time, in the present embodiment, in S70, the controller 6 calculates an expected arrival time at the destination P from the position (the distance to the destination P) and the moving speed of each of the smartphones 32. The controller 6 then excludes from the display target the smartphone 32 whose arrival time is determined to exceed a predetermined time (a target arrival time+α (e.g., 10 minutes)), and displays only the position information of each of the members who will arrive. This process for acquiring and displaying the member position information is executed repeatedly in a predetermined time (e.g., 10 seconds).

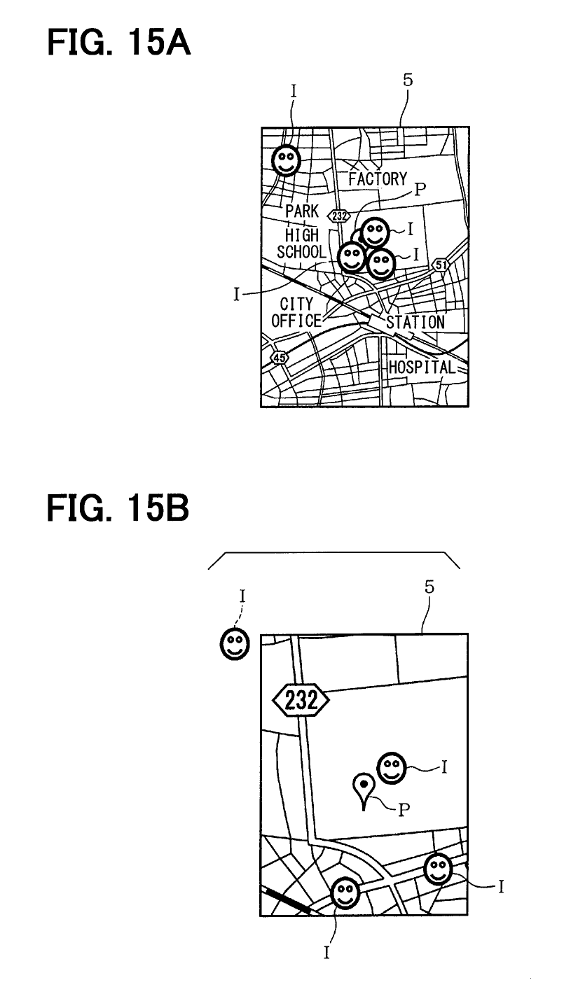

Since the smartphone 32 of the member whose arrival time at the destination P is extremely late is excluded from the display target, the map reduced scale does not need to be made smaller than necessary in order to display all the members, thereby enabling easily viewable display. FIGS. 15A and 15B show display examples of the display part 5 in a case where one of four members will be late. FIG. 15A shows a case where the positions of all the members (all the smartphones 32) are displayed, and FIG. 15B shows a case where the member whose arrival time is late has been excluded from the display target.

As can also be understood from FIG. 11, as shown in FIG. 15A, the map reduced scale is relatively small and the face icons I of three people, except for one in the upper left on the screen, are displayed in an adjacent and clustered state, and hence the positional relation among the three people (the positional relation with respect to the destination P) is hard to identify. In contrast, as shown in FIG. 15B, the map reduced scale is relatively large, and the positions of the three people (the positional relation with respect to the destination P) can be displayed in an easily viewable manner.

As above, according to the present embodiment, similarly to the above first embodiment, it is possible to share position information among the group members and obtain an excellent effect of being able to display position information of each member in an easily viewable state for the user. Since the member whose arrival time at the destination P is determined to exceed a predetermined time is excluded from the display target, the map reduced scale does not need to be made smaller than necessary in order to display all the members, thereby enabling easily viewable display.

Further, particularly in the present embodiment, since it is determined whether each user (member) is moving by automobile, moving by bicycle, or stopping home, based on the presence or absence and the kind of the connected device connected to the smartphone 32, it is possible to also obtain an advantage of being able to estimate the moving speed of the smartphone 32 of each member with sufficient certainty.

Although the smartphone 32 of the member whose arrival time at the destination P is determined to exceed the predetermined time is excluded from the display target in the above third embodiment, it may be configured for a similar purpose such that the smartphone 32 whose distance from the destination P exceeds a predetermined distance is simply excluded from the display target. In this case, the controller 6 can be functioned as the distance calculator. Since the member whose distance from the destination P is extremely large is excluded from the display target, the map reduced scale does not need to be made smaller than necessary in order to display all the members, thereby enabling easily viewable display.

Although it has been configured such that the position information management server 33 estimates (calculates) the moving speed of each smartphone 32 in the above embodiment, the moving speed may be estimated on each smartphone 32 side. Moreover, when the smartphone 32 is connected to a device such as the vehicle navigation apparatus 22, it may be configured such that the moving speed is estimated (the arrival time at the destination P is determined) on the device side. It is a matter of course that the value “α” for determining whether the arrival time is late is not restricted to 10 minutes. When the target arrival time is not set, the determination may be made based on whether the arrival time is extremely late with respect to an average arrival time of a plurality of members.

### Fourth Embodiment

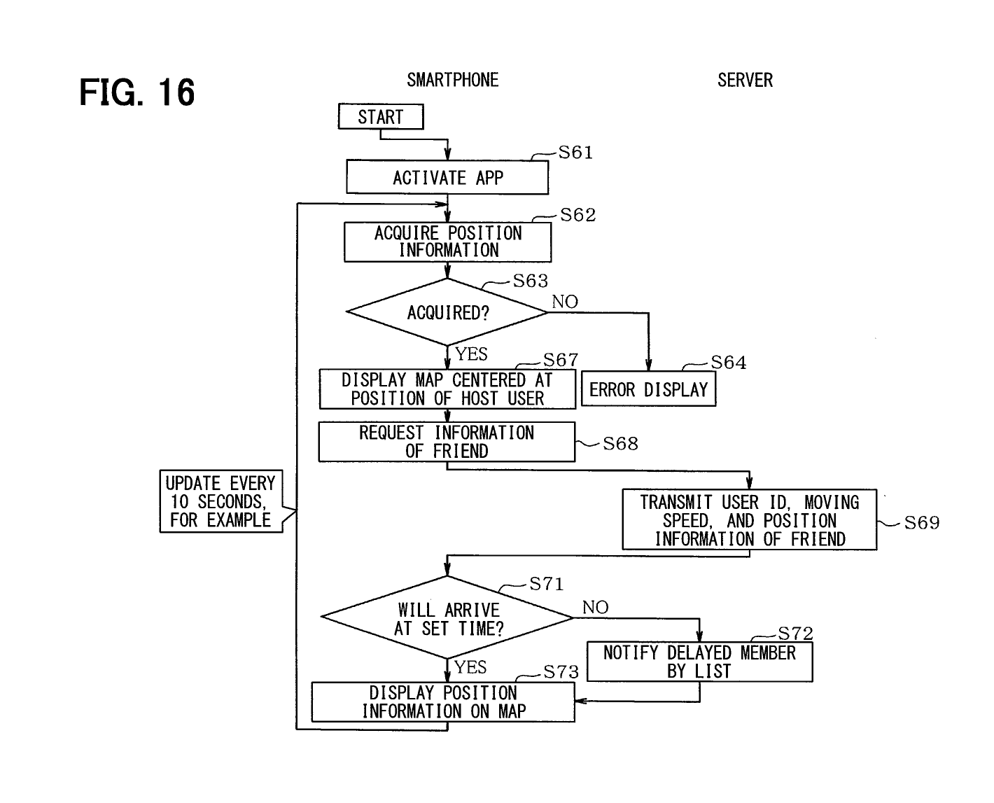

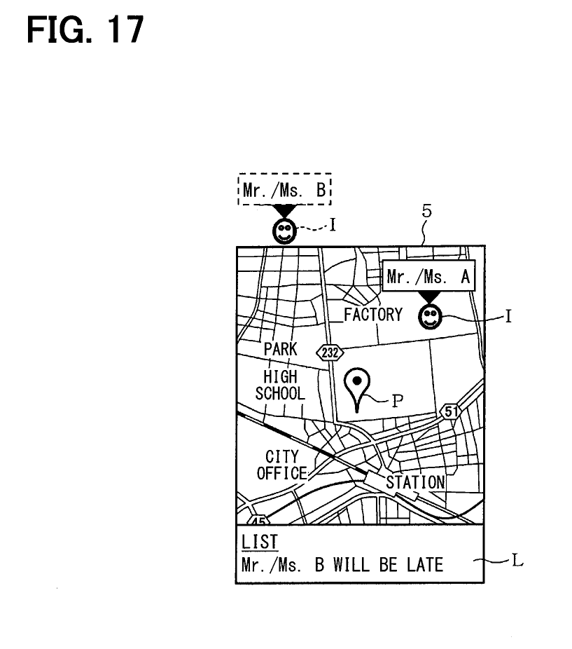

FIGS. 16 and 17 show a fourth embodiment of the present disclosure. The fourth embodiment is different from the third embodiment in that when the controller 6 of the smartphone 32 performs the shared-position-information display process, the smartphone 32, whose arrival time at the destination P is determined to exceed the predetermined time, is displayed in another mode on the screen of the display part 5 instead of being excluded from the display target. In this case, as the display in another mode, a list L of the member who will be late is displayed on part of the screen as shown in FIG. 17.

That is, a flowchart of FIG. 16 shows a process procedure for sharing (displaying) position information, executed by each smartphone 32 (the controller 6) and the position information management server 33 (the controller 12). Although a detailed description will be omitted, a similar process to that in the above third embodiment (the flowchart of FIG. 14) is performed in S61 to S69. In S69, when the User ID, the moving speed, and the position information (member position information) of each of the smartphones 32 of the members belonging to the group are transmitted from the position information management server 33, in S71, the smartphone 32 (the controller 6) calculates an expected arrival time at the destination P from the position (the distance to the destination P) and the moving speed of each of the smartphones 32, and determine whether each member will arrive by a set time.

A member determined not to arrive by the set time (NO in S71) is determined to be notified by a list (not displayed on the map) in S72 As for members determined to arrive by the set time (YES in S71) is determined, in S73, the position of each of the smartphones 32 of the group members is displayed with the face icons I on the screen of the display part 5, while the map reduced scale is automatically adjusted so as to be as large as possible. This process for acquiring and displaying the member position information is executed repeatedly in a predetermined time (e.g., 10 seconds).

Accordingly, as shown in FIG. 17, the member whose arrival time at the destination P will be extremely late (B in this case) is excluded from the display target with the face icons I in the map, and displayed in the list L for the delayed member. This eliminates the need to make the map reduced scale smaller than necessary in order to display all the members, thereby making the map reduced scale relatively large and enabling more easily viewable and identifiable display. An expected arrival time (how many minutes are the time required to arrive at the destination P), a remaining distance, and the like may also be displayed in the list L for the delayed member.

Also according to the fourth embodiment, similarly to the third embodiment, it is possible to share position information among group members and obtain an excellent effect of being able to display position information of each member in an easily viewable state for the user. Further, since the member whose arrival time at the destination P will be late is displayed in another mode (the list L), the map reduced scale does not need to be made smaller than necessary in order to display all the members, thereby enabling easily viewable display.

### Fifth Embodiment, Other Embodiments

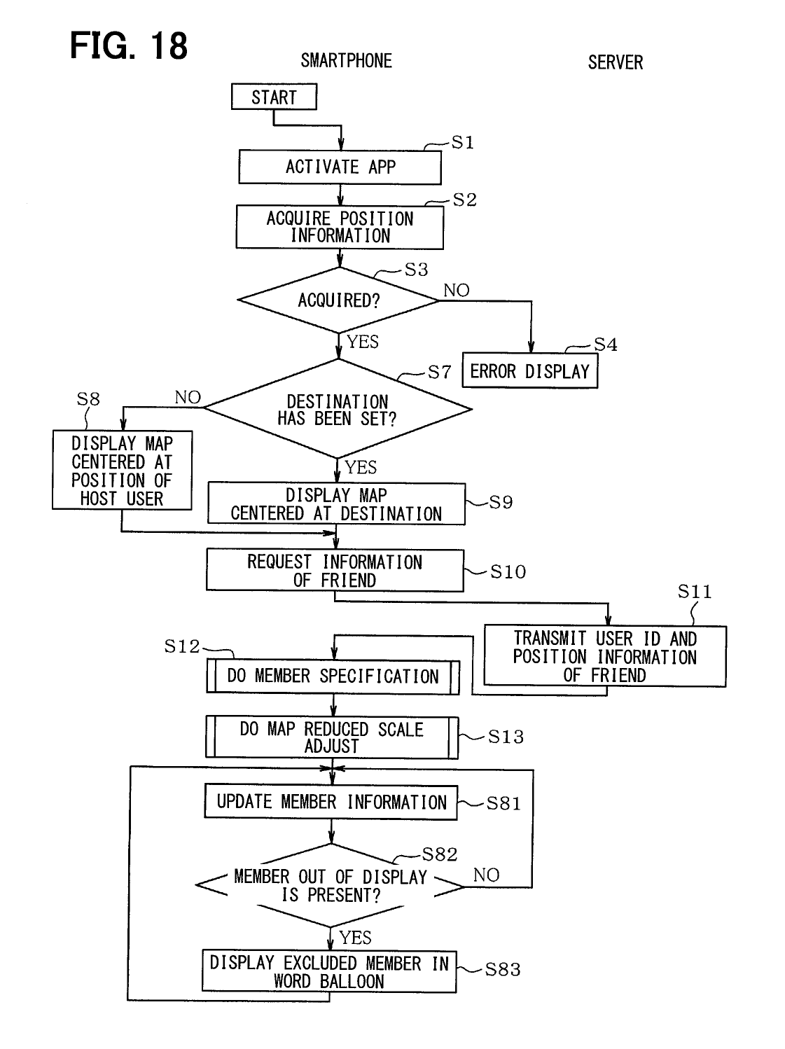

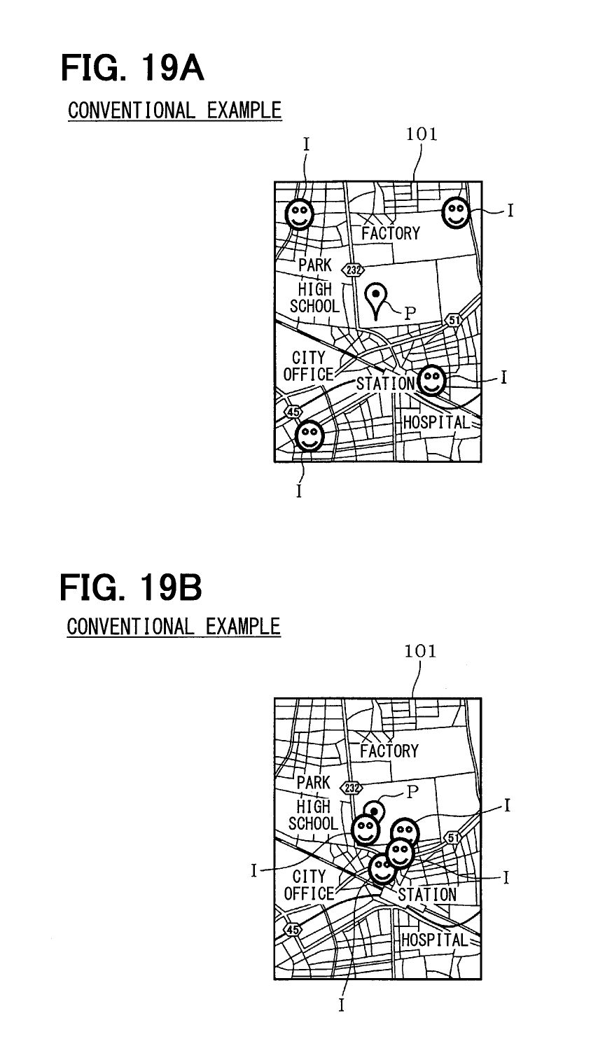

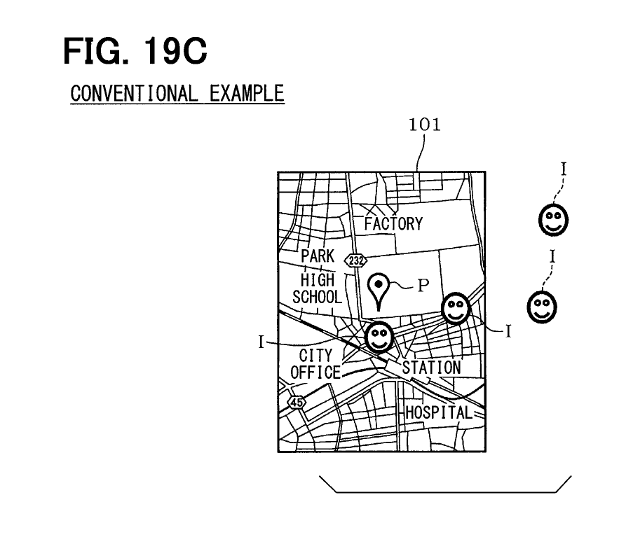

A flowchart of FIG. 18 shows a fifth embodiment of the present disclosure, showing a process procedure (main routine) concerning display of the shared position information, executed by the smartphone 2 and the position information management server 3. A flowchart of FIG. 18 is different from the flowchart of FIG. 3 of the above first embodiment in that the processes of S81 to S83 are performed after the process of adjusting the map reduced scale in S13.

That is, the member position information is updated, for example, 10 seconds later in S81, and in subsequent S82, the presence or absence of a member excluded from the display of the map screen (a member in a position out of the range of the map displayed last time) is determined. When the member out of the display of the map screen is present (YES in S82), the member is displayed in another display mode (a word balloon display) in S83.

In this case, even when some member temporarily moves in a direction away from the destination P, the display can be continued without making the map reduced scale smaller. Hence, it is possible to share the position information among the group members, continue the display without making the map reduced scale temporarily small, and display the position information of each member in an easily viewable state for the user.

Although the smartphone has been employed as the portable communication terminal in each of the above embodiments, the smartphone is not restrictive, and it is possible to use any portable equipment with a communication function, such as a portable phone, a tablet terminal, or a portable navigation device. The connection between the portable communication terminal and the on-board apparatus or other devices is not restricted by the connection in the bluetooth system, but wireless LAN (WiFi), or a cable (USB, HDMI (register trade mark), etc.) may be used. Furthermore, a variety of changes are possible in hardware configurations of the smartphone and the car navigation, and the like, and thus the present disclosure is not restricted to each of the embodiments described above and shown in the drawings, but can be implemented by being subjected to an appropriate change in the scope not deviating from the gist of the present disclosure.

The smartphones 2, 32 correspond to an example of the portable communication terminal. The communicator 4 corresponds to an example of the communication device. The display part 5 corresponds to an example of the display device. The controller 6 corresponds to an example of each of the host device position detector, the position information acquirer, the display controller, the separate distance calculator, the remaining distance calculator, and the time calculator. The GPS receiver 7 corresponds to an example of the host device position detector. The vehicle navigation apparatus 22 corresponds to an example of the on-board apparatus. The display part 23 corresponds to an example of the on-board display device. The controller 24 corresponds to an example of the on-board display controller. The bicycle navigation device 34 corresponds to an example of the other device. The storage mediums such as the storage 8, the storage 14, the memory 25, and the optical disk each correspond to an example of a computer readable non-transitory storage medium.

The present embodiment can be formed in a variety of modes, such as a computer readable non-transitory storage medium which records a program, a program product which is kept in a computer readable non-transitory storage medium, or the like.

It is noted that a flowchart or the processing of the flowchart in the present application includes multiple steps (also referred to as sections), each of which is represented, for instance, as S1. Further, each step can be divided into several sub-steps while several steps can be combined into a single step.

While various embodiments, configurations, and aspects of the portable communication terminal, position information sharing system, on-board apparatus, and program have been exemplified, the embodiments, configurations, and aspects of the present disclosure are not limited to those described above. For example, embodiments, configurations, and aspects obtained from an appropriate combination of technical elements disclosed in different embodiments, configurations, and aspects are also included within the scope of the embodiments, configurations, and aspects of the present disclosure.

What is claimed is:

1. A portable communication terminal comprising, in a body portable by an owner:
a communication device that communicates with an external portion;
a display device that displays information;
a host device position detector that detects a position of a host device;
a position information acquirer that acquires member position information, which is position information of a portable communication terminal owned by another member configuring a group with the owner, via the communication device; and
a display controller that performs a shared-position-information display process in which the position of each of the portable communication terminals owned by group members is displayed together with a map, on a screen of the display device, based on host device position information detected by the host device position detector and the member position information acquired by the position information acquirer; and
a separate distance calculator that calculates a separate distance between the host device and the portable communication terminal of another member, from the host device position and the member position information,
wherein:
at a time of performing the shared-position-information display process, the display controller specifies the portable communication terminal to be displayed, and adjusts a display of the map to a predetermined reduced scale, at which all positions of the portable communication terminals, which are specified, are displayed; and
when the portable communication terminals of a plurality of members to be displayed other than the host device are present, and when the separate distance between the host device and a portable communication terminal of a third member is larger than a predetermined value with respect to the separate distance between the host device and a portable communication terminal of a second member closest to the host device, the display controller excludes a position of the portable communication terminal of the third member from a display target, or displays the position of the portable communication termination of the third member by a word balloon or by a list as another mode.

2. The portable communication terminal according to claim 1, wherein:
at the time of performing the shared-position-information display process, the display controller adjusts a map reduced scale such that the map includes all the positions of the portable communication terminals to be displayed and also the map reduced scale is as large as possible.

3. (canceled)

4. The portable communication terminal according to claim 1, wherein:
a destination at which the group members are to meet is configured to be set; and
at the time of performing the shared-position-information display process, the display controller displays the position of each of the portable communication terminals of the group members together with the map, with the destination or the host device position at a center.

5. The portable communication terminal according to claim 1, wherein:
a destination at which the group members are to meet is configured to be set; and
at the time of performing the shared-position-information display process, the display controller adjusts the map reduced scale such that the map includes the destination and the host device position.

6. A portable communication terminal comprising, in a body portable by an owner:
a communication device that communicates with an external portion;
a display device that displays information;
a host device position detector that detects a position of a host device;
a position information acquirer that acquires member position information, which is position information of a portable communication terminal owned by another member configuring a group with the owner, via the communication device;
a display controller that performs a shared-position-information display process in which the position of each of the portable communication terminals owned by group members is displayed together with a map, on a screen of the display device, based on host device position information detected by the host device position detector and the member position information acquired by the position information acquirer;
a destination setting part that is configured to set a destination at which the group members are to meet; and
a remaining distance calculator that calculates a remaining distance from the position of each of the portable communication terminals of the group members to the destination,
wherein:
at a time of performing the shared-position-information display process, the display controller specifies the portable communication terminal to be displayed, and adjusts a display of the map to a predetermined reduced scale, at which all positions of the portable communication terminals, which are specified, are displayed; and
when the portable communication terminals of the plurality of members to be displayed other than the host device are present, and when the remaining distance from the portable communication terminal of a third member to the destination is larger than a predetermined value with respect to the remaining distance of the portable communication terminal of a second member to the destination, the second member being closest to the destination, the display controller excludes the position of the portable communication terminal of the third member from a display target, or displays the position of the portable communication terminal of the third member by a word balloon or by a list as another mode.

7. The portable communication terminal according to claim 1, wherein:
a destination at which the group members are to meet is configured to be set;
the portable communication terminal further comprises
a speed estimator that estimates a moving speed of each of the portable communication terminals of the group members, and
a time calculator that calculates an arrival time at the destination, based on the moving speed of each of the portable communication terminals of the group members; and
at the time of performing the shared-position-information display process, the display controller excludes from a display target a portable communication terminal whose arrival time at the destination is determined to exceed a predetermined time, or displays the portable communication terminal whose arrival time at the destination is determined to exceed the predetermined time by a word balloon or by a list as another mode.

8. The portable communication terminal according to claim 1, wherein:
at the time of performing the shared-position-information display process, the display controller acquires a latest member position information and updates the display in a predetermined time interval, and adjusts the display of the map to a predetermined reduced scale, at which all the positions of the respective portable communication terminals to be displayed are displayed.

9. The portable communication terminal according to claim 1, wherein:
at the time of performing the shared-position-information display process, the display controller acquires a latest member position information and updates the display in a predetermined time interval, and when a predetermined member stops being displayed on the displayed map during update, the display controller excludes the position of the portable communication terminal of the predetermined member from a display target, or displays the portable communication terminal of the predetermined member by a word balloon or by a list as another mode.

10. The portable communication terminal according to claim 1, further comprising:
a connector that connects another device to the body,
wherein:
the portable communication terminal is capable of cooperating with the connected another device connected by the connector.

11. A position-information sharing system comprising:
a portable communication terminal that is owned by each member configuring a group;
a position information management server that is capable of communicating with each of the portable communication terminals; and
an on-board apparatus that is provided in a vehicle which each of the members is in and connectable with each of the portable communication terminals,
wherein:
the portable communication terminal includes, in a body portable by an owner,
a communication device that communicates with an external portion,
a display device that displays information,
a connector that connects with the on-board apparatus,
a host device position detector that detects a position of a host device,
a transmitter that transmits host device position information detected by the host device position detector to the position information management server via the communication device,
a position information acquirer that acquires member position information, which is position information of a portable communication terminal owned by another member configuring the group, from the position information management server via the communication device,
a display controller that performs a shared-position-information display process in which the position of each of the portable communication terminals of the group members is displayed, together with a map, on a screen of the display device, based on the host device position information detected by the host device position detector and the member position information acquired by the position information acquirer, and
a transfer part that transfers the member position information, which is acquired, to the on-board apparatus;
the position information management server includes
a receiver that receives member position information, which is position information of each of the portable communication terminals of the members configuring the group, from each of the portable communication terminals of each of the members, and
a transmitter that transmits the member position information to each of the portable communication terminals configuring the group;
the on-board apparatus includes
an on-board display device provided in a cabin and capable of displaying a host-vehicle position on the map,
a connector connected with the portable communication terminal, and,
an on-board display controller that performs the shared-position-information display process in which the position of each of the portable communication terminals of the group members is displayed together with the map, on a screen of the on-board display device, based on host device position information and the member position information transferred from the portable communication terminal, and
a separate distance calculator that calculates a separate distance between the host device and the portable communication terminal of another member, from the host device position and the member position information;
at a time of performing the shared-position-information display process, the on-board display controller specifies each of the portable communication terminals to be displayed, and adjusts a display of the map to a predetermined reduced scale, at which all the positions of the specified portable communication terminals are displayed; and
in the shared-position-information display process, when the portable communication terminals of a plurality of members to be displayed other than the host device are present, and when the separate distance between the host device and a portable communication terminal of a third member is larger than a predetermined value with respect to the separate distance between the host device and a portable communication terminal of a second member closest to the host device, the display controller excludes a position of the portable communication terminal of the third member from a display target, or displays the position of the portable communication termination of the third member by a word balloon or by a list as another mode.

12. The position-information sharing system according to claim 11, wherein:
in the portable communication terminal, at the time of performing the shared-position-information display process, the display controller is capable of adjusting a map reduced scale on the screen of the display device independently from the screen of the on-board display device.

13. An on-board apparatus that is mounted in a vehicle which each of members is in and configures the position-information sharing system according to claim 11, the on-board apparatus comprising:
an on-board display device that is provided in a cabin and capable of displaying a host-vehicle position on a map; and
a connector that is connected with the portable communication terminal; and
an on-board display controller that performs the shared-position-information display process in which a position of each of the portable communication terminals of the group members is displayed together with the map, on the screen of the on-board display device, based on host device position and the member position information transmitted from each of the portable communication terminals; and
a separate distance calculator that calculates a separate distance between the host device and the portable communication terminal of another member, from the host device position and the member position information,
wherein:
at a time of performing the shared-position-information display process, the on-board display controller specifies each of the portable communication terminals to be displayed, and adjusts a display of the map to a predetermined reduced scale, at which all the positions of the portable communication terminals, which are specified, are displayed; and
when the portable communication terminals of a plurality of members to be displayed other than the host device are present, and when the separate distance between the host device and a portable communication terminal of a third member is larger than a predetermined value with respect to the separate distance between the host device and a portable communication terminal of a second member closest to the host device, the display controller excludes a position of the portable communication terminal of the third member from a display target, or displays the position of the portable communication termination of the third member by a word balloon or by a list as another mode.

14. A non-transitory computer readable storage medium storing a program causing a computer to execute a shared-position-information display process, the computer being incorporated into a portable communication terminal which includes, in a body portable by an owner, a communication device that communicates with an external portion and a display device that displays information, the program causing the computer to:
detect a position of a host device;
acquire member position information, which is position information of each of portable communication terminals owned by another member configuring a group with the owner, via the communication device;
calculate a separate distance between the host device and the portable communication terminal of another member, from the host device position and the member position information; and
perform a shared-position-information display process in which the position of each of the portable communication terminals owned by the group members is displayed together with a map, on a screen of the display device, based on a detected host device position information and the acquired member position information, specify each of portable communication terminals to be displayed at a time of performing the shared-position-information display process, and adjust a display of the map to a predetermined reduced scale, at which all the positions of the portable communication terminals, which are specified, are displayed, at the time of performing the shared-position-information display process,
wherein:
in the shared-position-information display process, when the portable communication terminals of a plurality of members to be displayed other than the host device are present, and when the separate distance between the host device and a portable communication terminal of a third member is larger than a predetermined value with respect to the separate distance between the host device and a portable communication terminal of a second member closest to the host device, the display controller excludes a position of the portable communication terminal of the third member from a display target, or displays the position of the portable communication termination of the third member in another mode.

15. (canceled)

16. A position-information sharing system comprising:
a portable communication terminal that is owned by each member configuring a group;
a position information management server that is capable of communicating with each of the portable communication terminals; and
an on-board apparatus that is provided in a vehicle which each of the members is in and connectable with each of the portable communication terminals,
wherein:
the portable communication terminal includes, in a body portable by an owner,
a communication device that communicates with an external portion,
a display device that displays information,
a connector that connects with the on-board apparatus,
a destination setting part that is configured to set a destination at which the group members are to meet,
a host device position detector that detects a position of a host device,
a transmitter that transmits host device position information detected by the host device position detector to the position information management server via the communication device,
a position information acquirer that acquires member position information, which is position information of a portable communication terminal owned by another member configuring the group, from the position information management server via the communication device,
a display controller that performs a shared-position-information display process in which the position of each of the portable communication terminals of the group members is displayed, together with a map, on a screen of the display device, based on the host device position information detected by the host device position detector and the member position information acquired by the position information acquirer, and
a transfer part that transfers the member position information, which is acquired, to the on-board apparatus;
the position information management server includes
a receiver that receives member position information, which is position information of each of the portable communication terminals of the members configuring the group, from each of the portable communication terminals of each of the members, and
a transmitter that transmits the member position information to each of the portable communication terminals configuring the group;
the on-board apparatus includes
an on-board display device provided in a cabin and capable of displaying a host-vehicle position on the map,
a connector connected with the portable communication terminal,
an on-board display controller that performs the shared-position-information display process in which the position of each of the portable communication terminals of the group members is displayed together with the map, on a screen of the on-board display device, based on the destination, host device position, and the member position information transferred from the portable communication terminal, and
a remaining distance calculator that calculates a remaining distance from the position of each of the portable communication terminals of the group members to the destination;
at a time of performing the shared-position-information display process, the on-board display controller specifies each of the portable communication terminals to be displayed, and adjusts a display of the map to a predetermined reduced scale, at which all the positions of the specified portable communication terminals are displayed; and
when the portable communication terminals of the plurality of members to be displayed other than the host device are present, and when the remaining distance from the portable communication terminal of a third member to the destination is larger than a predetermined value with respect to the remaining distance of the portable communication terminal of a second member to the destination, the second member being closest to the destination, the display controller excludes the position of the portable communication terminal of the third member from a display target, or displays the position of the portable communication terminal of the third member by a word balloon or by a list as another mode.

17. An on-board apparatus that is mounted in a vehicle which each of members is in and configures the position-information sharing system according to claim 16, the on-board apparatus comprising:
an on-board display device that is provided in a cabin and capable of displaying a host-vehicle position on a map; and
a connector that is connected with the portable communication terminal;
an on-board display controller that performs the shared-position-information display process in which a position of each of the portable communication terminals of the group members is displayed together with the map, on the screen of the on-board display device, based on the destination, host device position, and the member position information transmitted from each of the portable communication terminals; and
a remaining distance calculator that calculates a remaining distance from the position of each of the portable communication terminals of the group members to the destination,
wherein:
at a time of performing the shared-position-information display process, the on-board display controller specifies each of the portable communication terminals to be displayed, and adjusts a display of the map to a predetermined reduced scale, at which all the positions of the portable communication terminals, which are specified, are displayed; and
when the portable communication terminals of the plurality of members to be displayed other than the host device are present, and when the remaining distance from the portable communication terminal of a third member to the destination is larger than a predetermined value with respect to the remaining distance of the portable communication terminal of a second member to the destination, the second member being closest to the destination, the display controller excludes the position of the portable communication terminal of the third member from a display target, or displays the position of the portable communication terminal of the third member by a word balloon or by a list as another mode.

18. A non-transitory computer readable storage medium that stores a program causing a computer to execute a shared-position-information display process, the computer being incorporated into a portable communication terminal which includes, in a body portable by an owner, a communication device that communicates with an external portion and a display device that displays information, the program causing the computer to:
detect a position of a host device;
acquire member position information, which is position information of each of portable communication terminals owned by another member configuring a group with the owner, via the communication device;
set a destination at which the group members are to meet;
calculates a remaining distance from the position of each of the portable communication terminals of the group members to the destination; and
perform a shared-position-information display process in which the position of each of the portable communication terminals owned by the group members is displayed together with a map, on a screen of the display device, based on a detected host device position information and the acquired member position information, specify each of portable communication terminals to be displayed at a time of performing the shared-position-information display process, and adjust a display of the map to a predetermined reduced scale, at which all the positions of the portable communication terminals, which are specified, are displayed, at the time of performing the shared-position-information display process,
wherein:
when the portable communication terminals of the plurality of members to be displayed other than the host device are present, and when the remaining distance from the portable communication terminal of a third member to the destination is larger than a predetermined value with respect to the remaining distance of the portable communication terminal of a second member to the destination, the second member being closest to the destination, the display controller excludes the position of the portable communication terminal of the third member from a display target, or displays the position of the portable communication terminal of the third member by a word balloon or by a list as another mode.
